(19) United States
(12) Patent Application Publication
(10) Pub. No.: US 2007/0097966 A1
(43) Pub. Date: May 3, 2007

(54) Device and method for indicating an initial router of a path in a packet switching network

(75) Inventors: Shwu-Yan Chang Scoggins, Oak Hill, VA (US); Chander Raja, Washington, DC (US); Manoj Sindhwani, Oak Hill, VA (US)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 11/438,431

(22) Filed: May 23, 2006

Related U.S. Application Data
(60) Provisional application No. 60/733,332, filed on Nov. 3, 2005.

(51) Int. Cl. H04L 12/56

(52) U.S. Cl. 370/389

(57) ABSTRACT

A router includes a transceiver operable to transmit and receive packets when operably connected to a communication network, and a processor cooperatively operable with the transceiver. The processor is associated with a unique network routable value and/or a physical address. The processor is configured to facilitate receiving a packet in accordance with the transceiver. The processor checks the packet for an indication to determine if the unique network routable address value and/or the physical address are to be inserted in a router location information field in the packet. If the packet has the indication, the processor inserts router location information indicative of the unique network routable address value and/or the physical address in the packet. The processor transmits the packet in accordance with the transceiver.

### CROSS-REFERENCE TO RELATED APPLICATIONS

This application claims the benefit of provisional application Ser. No. 60/733,332 filed 3 Nov. 2005, which is expressly incorporated herein by reference.

### FIELD OF THE INVENTION

The present invention relates in general to communication networks, and more specifically to packet switching networks.

### BACKGROUND OF THE INVENTION

In many situations, a subscriber or customer device can connect to a communication network at varied locations. Consider, for example, a voice over Internet protocol (VoIP) network. The device, such as a particular CPE (customer premises equipment), can connect to the network almost anywhere. The physical location, however, does not need to be specified, and can remain unknown to the communication network.

There are many reasons why the location might not be known. For example, the CPE may be mobile, with an IP (Internet protocol) address and/or physical address that can change. Moreover, some users may be unwilling to provide physical address information or IP address information. Other users may be unable to do so, for example, where the input means is inconvenient or unavailable, where the user is not sure of the location, or when the user has limited capacity.

The unknown location can make it difficult to provide location specific services where the CPE is located. Such location specific services can include emergency dispatch (for example E911), roadside assistance, state police, and/or electronic surveillance (for example, under CALEA (Communications Assistance to Law Enforcement Act)).

Nevertheless, most users assume that when they dial an emergency dispatch number (such as 911) they will reach a dispatcher who can immediately determine their physical address and dispatch the necessary services. As users increasingly turn to communications networks to make phone calls using voice such as over VoIP, that assumption may be wrong.

### SUMMARY OF THE INVENTION

Accordingly, one or more embodiments of the present invention provide a router. The router can include a transceiver operable to transmit and receive packets when connected to a communication network; and a processor cooperatively operable with the transceiver. The processor is associated with at least one of a unique network routable address value and a physical address. The processor is configured to facilitate receiving a packet in accordance with the transceiver; checking the packet for an indication to determine if the at least one of the unique network routable address value and the physical address are to be inserted in a router location information field in the packet. If the packet has the indication, the processor inserts router location information indicative of the at least one of the unique network routable address value and the physical address in the packet. The processor facilitates transmitting the packet in accordance with the transceiver.

Optionally, the processor is further configured to facilitate obtaining the router location information from an initial router configuration.

Alternative embodiments provide that a header in the packet incorporates the indication and the router location information field, and the header is a layer 2 header, a layer 3 header, a layer 4 header, and/or an application layer header. Another alternative embodiment provides that a header in the packet incorporates the indication, the header indicates the router location information field is an extended field, and the header is a layer 2 header, a layer 3 header, a layer 4 header, and/or an application layer header. A further alternative embodiment provides that a header in the packet incorporates the indication, the router location information field is incorporated in a payload of the packet, and the header is a layer 2 header, a layer 3 header, a layer 4 header, and/or an application layer header.

Optionally, the router location information further comprises a line card number and/or a port number associated with the packet.

Before inserting the router location information, the processor can check whether the router information location field has the router location information.

Other embodiments provide for computer-implemented method, implemented on a router in a packet switching network, for indicating a first router in a packet path. The method includes, at the router, associating the router with router location information, wherein the router location information is a network routable address value unique to the router and/or a physical address corresponding to a geographic location of the router. Also provided is, at the router, automatically checking whether each packet of a plurality of packets that are received and are to be forwarded includes an indication that the router location information is to be inserted. Furthermore, the method includes, at the router, if the packet includes the indication, automatically inserting the router location information into a router location information field in the packet; and if the packet does not include the indication, automatically not inserting router location information into the packet.

The packet switching network can be a voice over packet (VOP) network.

The packet may be received by the computer before the checking and inserting. The method may include transmitting the packet with the router location information to a next router in the packet path.

Alternative embodiments provide that a header in the packet may include the indication, and the packet includes the router location information field as an extended field, wherein the header is a layer 2 header, a layer 3 header, a layer 4 header, and/or an application layer header. Alternatively, a header in the packet includes the indication, the router location information field is incorporated in a payload of the packet, and the header is a layer 2 header, a layer 3 header, a layer 4 header, and/or an application layer header. Another alternative provides that the indication is the router location information field in a header in the packet, and the header is a layer 2 header, a layer 3 header, a layer 4 header, and/or an application layer header.

Another embodiment provides a computer-readable medium having instructions for execution by a computer corresponding to a router, the instructions including a computer-implemented method for providing an indication of an initial router in a path for a packet on a packet switching network. The instructions provide for receiving a packet that is to be forwarded over the packet switching network. Also provided for is, responsive to receipt of the packet, processing the packet in accordance with an associated layer, including checking the packet to determine if any router location information is in the packet, and inserting specific router location information into the packet only if any router location information is not in the packet, where the specific router location information indicates the router that received the packet. Further provided for is forwarding the packet after the processing.

Optionally, the checking includes checking whether the packet includes an indication that router location information is to be inserted into a router location information field in the packet; and the inserting includes, only if the packet includes the indication, obtaining the specific router location information, and inserting the specific router location information into the packet.

Alternative embodiments provide that a header in the packet incorporates the router location information field, and the header is at least one of a layer 2 header, a layer 3 header, a layer 4 header, and an application layer header. Another alternative provides that a header in the packet indicates the router location information field as an extended field, and the header is at least one of a layer 2 header, a layer 3 header, a layer 4 header, and an application layer header. According to yet another alternative, the router location information field is incorporated in a payload of the packet.

The router location information may be a unique network routable address value associated with the router corresponding to the computer that is executing the instructions, and/or a physical address corresponding to a geographic location of the router. Also include are instructions for obtaining the router location information to be inserted.

Optionally, there are provided instructions for initially configuring the computer executing the instructions to provide the specific router location information.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

### BRIEF DESCRIPTION OF THE DRAWINGS

The accompanying figures, where like reference numerals refer to identical or functionally similar elements and which together with the detailed description below are incorporated in and form part of the specification, serve to further illustrate various exemplary embodiments and to explain various principles and advantages in accordance with the present invention.

FIG. 1 is a diagram illustrating a simplified and representative environment associated with packet forwarding in an exemplary packet switching network;

FIG. 2 is a packet flow diagram illustrating an exemplary packet flow in connection with the environment of FIG. 1;

FIG. 3 is a block diagram illustrating an exemplary packet;

FIG. 4 is a block diagram illustrating an exemplary first header;

FIG. 5 is a block diagram illustrating an exemplary second header;

FIG. 6 is a block diagram illustrating an exemplary third header;

FIG. 7 is a block diagram illustrating an exemplary header and payload;

FIG. 8 is a block diagram illustrating portions of an exemplary router;

FIG. 9 is a flow chart illustrating an exemplary procedure for indicating a first router in a packet path; and

FIG. 10 is a flow chart illustrating an exemplary procedure for providing an indication of an initial router in a path for a packet.

### DETAILED DESCRIPTION

In overview, the present disclosure concerns communication networks, including packet switching networks, or more particularly voice over packet (VOP) networks, and even more particularly voice over Internet protocol (VoIP) networks. Such communication networks may be associated with networks supporting communication between wireless and/or wire line devices. Such communication networks may provide services such as voice communications, data communications, media communications, signal services, and/or video services, or similar services. Such networks can include network infrastructure devices known as routers which transfer the communications between wireless and/or wire line devices, for example by forwarding the communications which may have been broken into communication packets. More particularly, various inventive concepts and principles are embodied in systems, devices, and methods therein for providing an indication of a first router in a path of a packet in a communication network.

The instant disclosure is provided to further explain in an enabling fashion the best modes of performing one or more embodiments of the present invention. The disclosure is further offered to enhance an understanding and appreciation for the inventive principles and advantages thereof, rather than to limit in any manner the invention. The invention is defined solely by the appended claims including any amendments made during the pendency of this application and all equivalents of those claims as issued.

It is further understood that the use of relational terms such as first and second, and the like, if any, are used solely to distinguish one from another entity, item, or action without necessarily requiring or implying any actual such relationship or order between such entities, items or actions. It is noted that some embodiments may include a plurality of processes or steps, which can be performed in any order, unless expressly and necessarily limited to a particular order; i.e., processes or steps that are not so limited may be performed in any order.

Much of the inventive functionality and many of the inventive principles when implemented, are best supported with or in software or integrated circuits (ICs), such as a digital signal processor and software therefor, and/or application specific ICs. It is expected that one of ordinary skill, notwithstanding possibly significant effort and many design choices motivated by, for example, available time, current technology, and economic considerations, when guided by the concepts and principles disclosed herein will be readily capable of generating such software instructions or ICs with minimal experimentation. Therefore, in the interest of brevity and minimization of any risk of obscuring the principles and concepts according to the present invention, further discussion of such software and ICs, if any, will be limited to the essentials with respect to the principles and concepts used by the exemplary embodiments.

As further discussed herein below, various inventive principles and combinations thereof are advantageously employed to provide location information (for example, an IP (Internet protocol) address and/or physical address) of the first router near a device (such as a CPE) that originated a packet transmission. The first router receiving a packet from the device is typically physically close to the device, and generally will receive the majority of the packets from the device. The first router indicates its location information in the packet. The routers that subsequently receive the packet check for this indication, and if the location information is already indicated, then the subsequent routers do not indicate their location information. Therefore, the packet indicates a physical location that should be close to the device that originated the packet transmission, and/or a logical address on the network that receives most of the packets from the device. Consequently, a network does not need to control or track a device's location. Moreover, the device does not need to generate additional signals from which its location can be tracked.

Further in accordance with exemplary embodiments, there is provided a router, a method and/or a computer program device for receiving a packet, adding router location information to a packet when the packet does not already have such information, and forwarding the packet.

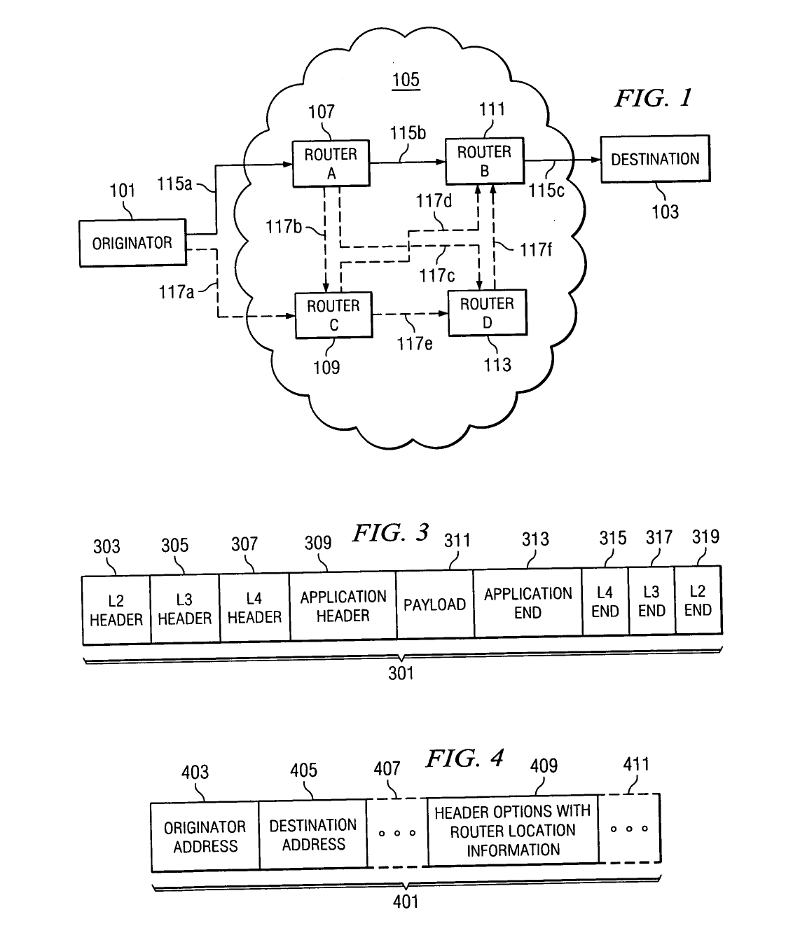

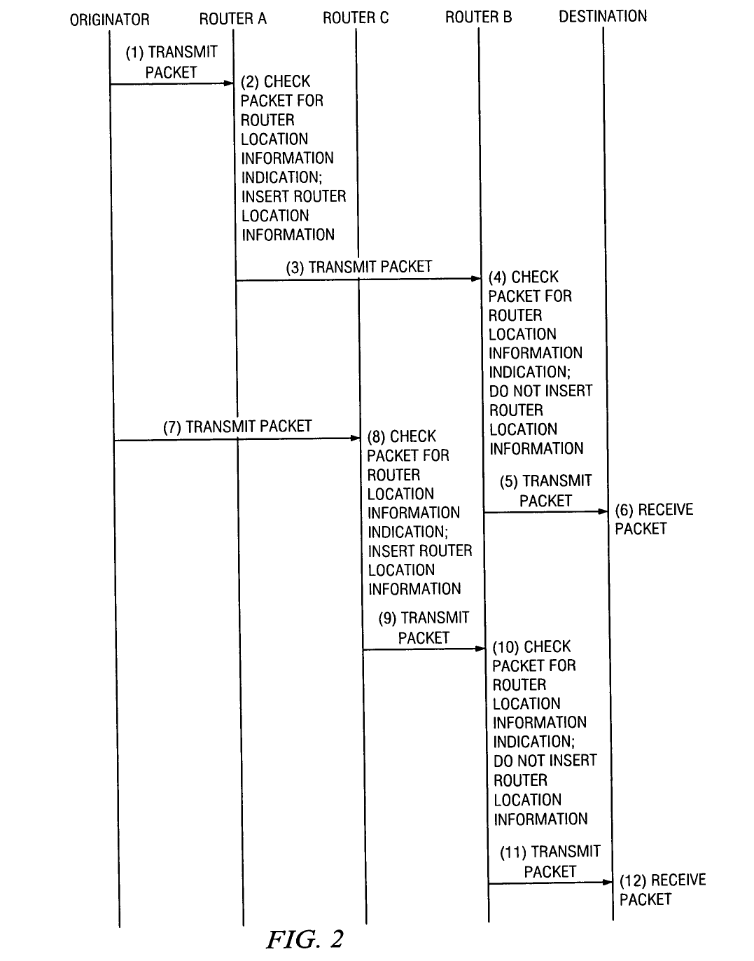

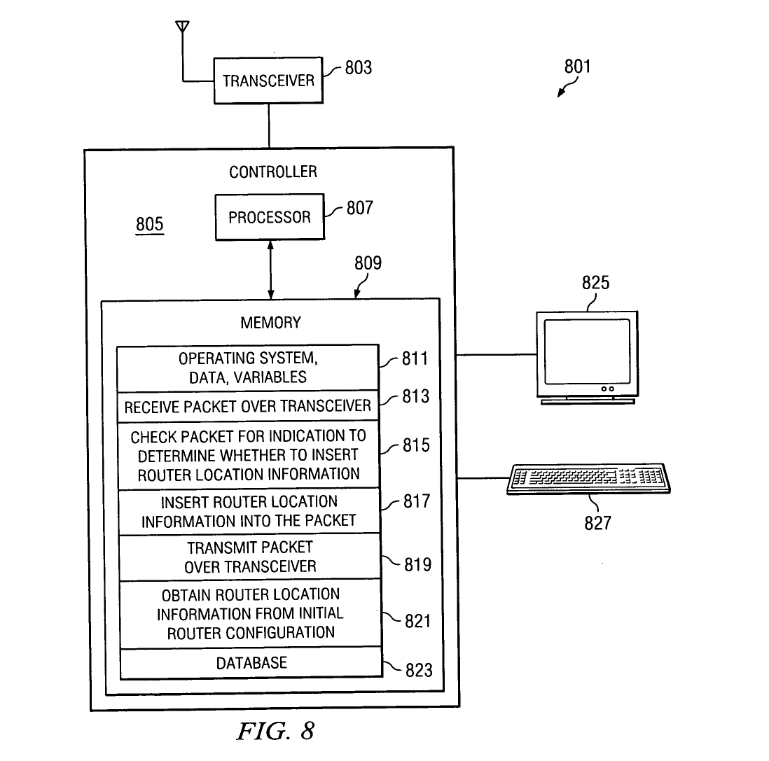

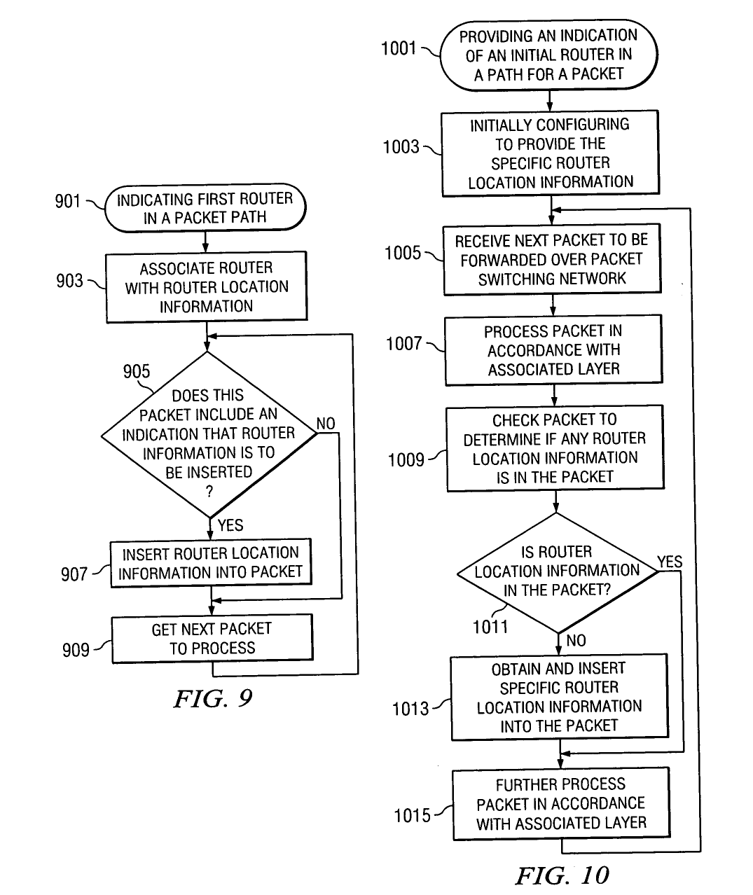

In overview, FIG. 1 illustrates paths for packets in a simplified example packet switching network; and FIG. 2 is utilized to discuss a simplified example of packet flow for packets received and forwarded along some of the paths corresponding to FIG. 1. FIG. 3-FIG. 7 are utilized in connection with a discussion of various illustrative packets formatted and processed according to a hierarchy of layers, which in these illustrations is the OSI (open systems interconnection) model. FIG. 8 illustrates an example implementation on a simplified example router. FIG. 9 and FIG. 10 are flow charts illustrating various processes used in this connection.

Referring now to FIG. 1, a diagram illustrating a simplified and representative environment associated with packet forwarding in an exemplary packet switching network will be discussed and described. A packet switching network 105 includes routers, here represented by Router A, Router B, Router C and Router D 107, 109, 111, 113, although a typical network can include a substantially greater number of routers. A router typically incorporates a computer. Also illustrated are an originator 101 and a destination 103, which can be, for example, a CPE (customer premises equipment). The originator 101 can transmit a message to the destination 103 via the network 105. The message can be divided into packets (in accordance with well known techniques), such that each packet is transmitted from the originator 101 to the destination 103 over the some (or all) of the routers 107, 109, 111, 113 in the packet switching network 105.

Each packet can take a different path through the routers 107, 109, 111, 113 in the packet switching network 105 in order to reach the destination 103. In the illustration of FIG. 1, a packet may be sent from the originator 101 along a first packet path 115a, 115b, 115c to Router A 107, to Router B 111, then to the destination 103. However, packets can be sent from the originator 101 along an alternative packet path which may include one or more alternatives 117a, 117b, 117c, 117d, 117e, 117f.

The initial router to which the originator 101 transmits any packet is not necessarily the same as the initial router for subsequent packets. The initial router tends to be the router which is physically closest to the originator 101. This is, however, not always the situation. In any event the originator 101 might be mobile and hence might have a physically different location over time. In the illustrated example, the initial router for any packet can be Router A 107 or Router C 109.

The router 107, 109, 111, 113 that receives a packet checks to see if the packet includes router location information. If the packet does not include router location information, the router can indicate its specific router location information in the packet. Then, the router can forward the packet. Accordingly, one or more embodiments can provide that the packet is received by the computer before the checking and inserting, further comprising transmitting the packet with the router location information to a next router in the packet path.

Consequently, the first router to receive a packet, in this illustration Router A 107, indicates its location information in the packet and then forwards the packet as usual. The subsequent routers, in this case Router B 111, check for this indication; because the location information is already indicated, the subsequent routers do not indicate their location information. Then, the subsequent routers forward the packet as usual. The packet retains the indication of the router location information inserted by the first router (for example, Router A 107). The destination 103 (and any intervening router(s)) can obtain the router location information from the packet, and can thereby determine the router location information for the first router that received the packet.

The ability to locate the first router in a packet path tends is important for voice data applications. Although a packet switching network can be used for various types of packets, it is anticipated to be particularly useful for voice over packet (VOP) networks. Moreover, such VOP network can be a VoIP (voice over Internet Protocol) network. For example, the first router can be useful in location specific services, such as 911, E911, roadside assistance, state police, and/or electronic surveillance (for example, under CALEA (Communications Assistance to Law Enforcement Act)), where there can be a need to know a physical location in proximity to where the communication originated. Accordingly, the communication network can be a packet switching network. Moreover, the packet switching network can be a voice over packet (VOP) network. More specifically, the communication network can be a voice over IP (VoIP) network.

Referring now to FIG. 2, a packet flow diagram illustrating an exemplary packet flow will be discussed and described. FIG. 2 is utilized to discuss a simplified example of packet flow for packets from an originator which are forwarded along some of the routers (Router A, Router B and Router C) to the destination, corresponding to FIG. 1.

In this illustration, two packets are transmitted from the originator to the destination. In this example, the two packets take different routes through different routers in the packet switching network.

In this example, the first packet is routed through a packet path including Router A and Router B. The first packet is transmitted 1 from the originator to Router A. Router A checks 2 the packet for an indication of router location information. Because no router location information is indicated, Router A inserts its router location information, where the router location information is specific to Router A. Router A then transmits 3 the packet to the next router (determined, for example, in accordance with a standard routing algorithm), Router B. Router B checks 4 the packet for an indication of router location information. Finding that the packet includes the indication, Router B does not insert its router location information. Router B then transmits 5 the packet, in this case to the destination. The destination receives 6 the packet, and processes it as desired, including possibly referencing the router location information in the packet.

The packet path for the next packet in this example is via Router C and Router B. The next packet is transmitted 7 from the originator to Router C. Router C checks 8 the packet for an indication of router location information. Because no router location information is indicated, Router C inserts its router location information, where the router location information is specific to Router C. Router C then transmits 9 the packet to the next router, Router B. Router B checks 10 the packet for an indication of router location information. Because the packet includes the router location information, Router B does not insert its router location information. Router B then transmits 11 the packet to the destination, which receives 12 the packet and processes the packet as desired.

The router location information can be a logical location of the router on the network and/or a physical address corresponding to a geographic location of the router. The logical location of the router can be an address value unique to the router, for example a network routable address, or more particularly, an IP address value or similar value usable for ATM, DEC, SNA or the like. The physical address is intended to include, for example, a street address and equivalents thereof. It will be appreciated that it is not necessary for the physical address to be unique to the router.

The router location information may further include additional details. For example, the network routable address value can further include the line card number where the packet was received and/or the port number where the packet was received and/or similar router details to further identify the line or port where the packet was received. As another example, the physical address can further include, for example, router physical location details (such as building, floor, wing and/or room number). Accordingly, one or more embodiments provide that the router location information further comprises at least one of a line card number and a port number associated with the packet.

In overview, FIG. 3-FIG. 7 are utilized in connection with a discussion of various illustrative packets or packet headers formatted and processed according to a hierarchy of layers, which in these illustrations is the OSI (open systems interconnection) model. The principles discussed herein can be adapted to other communication packet formats and/or other communication protocols.

Referring now to FIG. 3, a block diagram illustrating an exemplary packet 301 will be discussed and described. The packet 301 can be formatted in accordance with various protocols, in this example, layered protocols, such as Ethernet, ATM or other protocols. The packet 301 as it is received and processed by the router is in a format, prescribed by a protocol, which typically includes one or more headers, a payload, and corresponding end indicators, and can include other fields which are omitted from this discussion but will be known in the industry.

In this example, the packet 301 includes Layer 2, Layer 3, Layer 4, and application layer data. There is illustrated a Layer 2 header 303, a Layer 3 header 305, a Layer 4 header 307, an application layer header 309, a payload 311, and application end indicator 313, a Layer 4 end indicator 315, a Layer 3 end indicator 317, and a Layer 2 end indicator 319. Other fields in the packet are omitted from the illustration, for clarity. Additional and/or alternative layers can also be provided, and the same principals discussed herein apply.

An indication of router location information can be placed in the packet, for example, in one or more of the headers 303, 305, 307, 309 and/or the payload 311. The possibilities for placing the indication in the packet are governed by considerations including the packet format being considered.

For example, if sufficient room is allocated in the header, the router location information can be placed in the header, such as in a router location information field. Alternatively, an indicator (such as a pointer, flag, reserved bit, or similar) can be provided in the header to indicate that a router location information field other than the indicator has the router location information; the router location information field can be located elsewhere in the header, in an extended header, in a payload, or in an other reserved field in the packet. Alternatively, the router location information can be placed in the extended header, in the payload, and/or in another reserved field without use of the indicator. As yet another alternative, the router location information can be initialized to, for example, zero, a negative value, or the like, to function as an indication that the router location information is not yet present in the packet.

Furthermore, an indication (such as a flag, reserved bit or similar) can be provided in the packet that router location information is to be inserted. When the indication that router location information is to be inserted is set to true, the router location information can be placed in the packet; whereas when the indication is false, no router location information is to be placed in the packet. This indication can either be separate from or the same as the indicator (discussed above) which indicates that the router location information field has the router location information and/or the indication of router location information.

A best practice is for the router location information to be inserted at the layer which is being operated on. For example, if a realization is implemented in Layer 3, the best practice is to indicate the router location information in a Layer 3 field. This can avoid a situation where a function at a different layer, for example, encryption/decryption, might inadvertently alter the router location information.

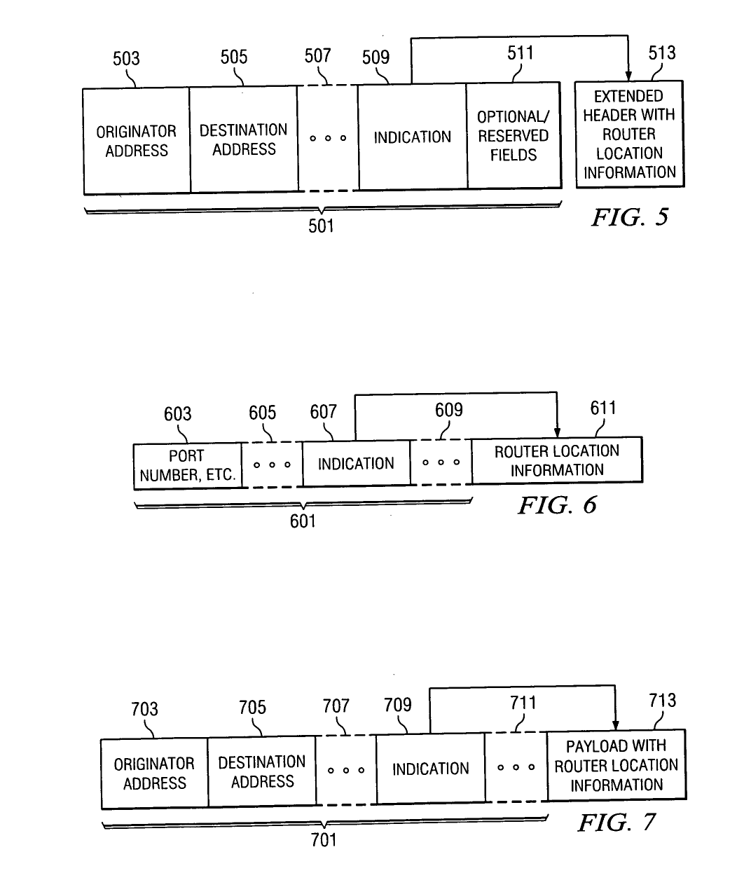

Various realizations can provide the indication and/or router location information in a packet in one or more places. FIG. 4, FIG. 5, FIG. 6 and FIG. 7 provide non-exhaustive examples to illustrate a variety of indications in portions of packets, for independent realizations respectively in Layer 3 IPv6 (Internet Protocol version 6), a Layer 3 IPv4 (IP version 4), Layer 4, and an application layer. Each is discussed in more detail below.

Referring now to FIG. 4, a block diagram illustrating an exemplary first header will be discussed and described. This example illustrates a packet header 401 having a format which has a size sufficient to incorporate a router location information field, for example, according to Layer 3 IPv6. The packet header 401 includes an originator address 403, a destination address 405, other fields 407 following the destination address, optional header fields 409 with at least the router location information, and other fields 411 following the optional header fields.

The header size in the illustrated example (Layer 3 IPv6 format) is sufficiently large or variable so as to accommodate all of the router location information (the unique IP address value and/or physical address). Therefore, all or a portion of the router location information can be directly included in one or more of the optional header fields 409.

Accordingly, a header in the packet can incorporate the indication and the router location information field, wherein the header is at least one of a layer 2 header, a layer 3 header, a layer 4 header, and an application layer header.

Referring now to FIG. 5, a block diagram illustrating an exemplary second header will be discussed and described. This example illustrates a packet header 501 where it is undesirable to contain the router location information, for example, a Layer 3 IPv4 format which has a strictly limited header size. The packet header 501 includes an originator address 503, a destination address 505, other fields 507 after the destination address, an indication of the router location information 509, and other optional and/or reserved fields 511.

The indication 509 can be a flag, pointer, or bit; in the illustrated embodiment, the indication 509 is a reserved bit. If the indication is true, the router location information is included in the packet, outside of the header 501.

In this example, the router location information can be included in an extended header field 513. Alternatives include placing the router location information in the field between the IP and transport headers. The extended header field 513 can have a size sufficient to include the router location information.

Accordingly, a header in the packet can incorporate the indication, and the header can indicate the router location information field is an extended field, wherein the header is at least one of a layer 2 header, a layer 3 header, a layer 4 header, and an application layer header.

Referring now to FIG. 6, a block diagram illustrating an exemplary third header will be discussed and described. This example illustrates a packet header 601 in accordance with Layer 4 format Some headers according to Layer 4 are fixed length (such as TCP (transmission control protocol) and UDP(user datagram protocol)), whereas other headers have a variable length (such as SCTP (stream control transmission protocol)). The packet header 601 includes a port number and the like 603 for the originator, and for the destination (in accordance with Layer 4 format), other fields 605 thereafter, an indication of the router location information 607, and other optional and/or reserved fields 609.

The indication 607 can be a flag, pointer, bit or the like; in the illustrated embodiment, the indication 607 is a reserved bit. If the indication is true, the router location information is included in the packet, outside of the header 601. In this example, the router location information can be included in an extended header field 611 or in another field outside of the payload and the header.

Moreover, a header in the packet can incorporate the indication, and the header can indicate the router location information field is an extended field, wherein the header is at least one of a layer 2 header, a layer 3 header, a layer 4 header, and an application layer header.

Referring now to FIG. 7, a block diagram illustrating an exemplary header and payload will be discussed and described. This example illustrates a packet header 701 and payload 713 according to the application layer. The packet header 701 includes an originator address 703, a destination address 705, other fields 707 following the destination address 705, an indication of the router location information 709, and other optional and/or reserved fields 711.

If the indication 709 is true, the router location information is included in the packet, in the payload 713. The router location information can be included in any payload field, for example, it can be in the first field of the payload.

Accordingly, a header in the packet can incorporate the indication, and the router location information field can be incorporated in a payload of the packet, wherein the header is at least one of a layer 2 header, a layer 3 header, a layer 4 header, and an application layer header.

Router location information can be provided in media packets and signaling packets, which take different packet paths through routers. Media packets and signaling packets are examples of packets according to the application layer format. Therefore, one or more embodiments useful with media and signaling packets include the router location information field in the payload. The payload field can include, for example, a signaling header (for a signaling packet, a media header (for a media packet), and a message body.

Where the packet is a signaling packet, the indication can be incorporated in the signaling header and/or the message body of the packet, for example where the packet is an SDP (session description protocol) packet. Where the packet is a media packet, the indication can be incorporated in the media header and/or the payload of the packet, for example the real time protocol (RTP) header and/or RTP payload.

For example, the SDP packet can utilize the packet payload, more specifically, the “a=” attribute line to describe the router location information. Therefore, according to one example, the message body content can include the IP address and the physical address:

a=router:IPv4|IPv6[address<xx.xx.xx.xx>].

a-router:phy street<xxxxx> city <xxxxx> [state<xxxxx>] zipcode <xxxxx> country <xxxxx>

The media packet (such as an RTP packet) can similarly include the network routable address and the physical address in the payload. Analogous formats can be utilized for SIP (session initiation protocol) packets, MGCP (media gateway control protocol) packets, MEGACO (media gateway control) packets, and other packets.

Encryption/decryption of packets can limit the choice of the appropriate layer and/or field for inserting router location information. Current techniques for encryption/decryption of packets provide that encryption typically operates on the Layer 4 header, payload and the Layer 4 end indication; and/or that encryption operates on the payload. If the Layer 4 header is encrypted, the Layer 4 header should not be altered subsequent to the encryption. Therefore, utilizing the extended Layer 4 header or an encrypted field for the router location information and/or the indication is not a viable option. However, according to current techniques, the Layer 3 approach will work without regard to encryption/decryption.

Referring now to FIG. 8, a block diagram illustrating portions of an exemplary router 801 will be discussed and described. The router 801 is assigned, in the usual manner, a unique logical address value for the communication network, for example an IP address value. The router 801 may include a transceiver 803 and one or more controllers 805. The transceiver 803 is representative of a combination of any number of transmitters and/or receivers, and may be wireless or wired. The controller 805 may include a processor 807, a memory 809, and other optional components which will be well understood to those in this field. A display (825) and a keyboard (827) and/or other display and input device for interacting with the user, such as a track ball, console, keypad, and/or similar can also be provided with the router 801.

The processor 807 may be, for example, one or more microprocessors and/or one or more digital signal processors. The memory 809 may be coupled to the processor 807 and may comprise a read-only memory (ROM), a random-access memory (RAM), a read/write flash memory, a programmable ROM (PROM), and/or an electrically erasable read-only memory (EEPROM). The memory 809 may include multiple memory locations for storing, among other things, an operating system, data and variables 811 for programs executed by the processor 807; computer programs for causing the processor to operate in connection with various functions such as receiving 813 a packet over the transceiver, checking 815 the packet for an indication to determine whether to insert router location information, inserting 817 router location information into the packet, transmitting 819 the packet over the transceiver, obtaining 821 router location information from an initial router configuration; and a database 823 of various information used by the processor 807. The computer programs may be stored, for example, in ROM or PROM and may direct the processor 807 in controlling the operation of the router 801. Each of these computer programs is discussed by way of example below.

The processor 807 may be programmed for receiving 813 a packet over the transceiver. The packet can be received in accordance with well known methods. Also, the processor 807 can have access to conventionally stored details corresponding to the transceiver on which the packet is received, for example, port number and/or line card number. One or more embodiments can include such transceiver details with the router location information.

Further, the processor 807 may be programmed for checking 815 the packet for an indication to determine whether to insert router location information. When the packet has been received, the processor 807 can then check the packet to see if router location information should be inserted. The indications in the packet associated with the router location information have been previously described. Accordingly, before inserting the router location information, whether the router information location field has the router location information can be checked. Where the router includes layered protocols, the packet can be checked at the appropriate layer.

The processor 807 may be programmed for inserting 817 the router location information into the packet, after it is determined that the router location information should be inserted. The router location information can be inserted into the packet in accordance with the descriptions provided above. If it is determined, however, that router location information should not be inserted, then this function can be omitted.

The processor 807 may be programmed for transmitting 819 the packet over the transceiver. The packet is transmitted in accordance with known techniques for forwarding a packet to a destination via a communication network. In particular, techniques are known for forwarding packets in packet switching networks, for example, VOP networks.

Accordingly, a router may include a transceiver operable to transmit and receive packets when operably connected to a communication network; and a processor cooperatively operable with the transceiver. The processor is associated with at least one of a unique network routable address value and a physical address. The processor is configured to facilitate receiving a packet in accordance with the transceiver; checking the packet for an indication to determine if the at least one of the unique network routable address value and the physical address are to be inserted in a router location information field in the packet; if the packet has the indication, inserting router location information indicative of the at least one of the unique network routable address value and the physical address in the packet; and transmitting the packet in accordance with the transceiver.

Optionally, the processor 807 can be provided with additional functions and/or enhancements, such as obtaining 821 the router location information from an initial router configuration. At least some of the router location information can be assigned to the processor 807 in an initial router configuration. Routers are conventionally configured during an initialization. For example, the network routable address can be obtained according to known techniques from the Internet service provider (ISP), the DHCP (dynamic host configuration protocol) server, or the like. The initial configuration may also be performed during a re-configuration of the router, for example, when the router changes its physical location. The initial configuration can further provide for interacting with the user (or another device) to input the physical address and any other desired router location information. Accordingly, the processor may be further configured to facilitate obtaining the router location information from an initial configuration of the router.

The router location information can then be retrieved from the initial router configuration. The router location information can alternatively be provided by interacting with the user (or another device) at a time other than initial configuration. Accordingly, the router location information can be at least one of a unique network routable address value associated with the router corresponding to the computer that is executing the instructions, and a physical address corresponding to a geographic location of the router; and the router can provide for obtaining the router location information to be inserted.

Moreover, a computer-readable medium may include instructions for execution by a computer, the instructions including a computer-implemented method for providing an indication of an initial router in a path for a packet on a packet switching network.

Also illustrated is the database 823 of various information used by the processor 807. The database 823 is provided for local storage of information. For example, the database 823 can be used for storing some or all of the router location information specific to the router 801.

It should be understood that various embodiments are described herein in connection with logical groupings of functions. One or more embodiments may omit one or more of these logical groupings. Likewise, in one or more embodiments, functions may be grouped differently, combined, or augmented.

Referring now to FIG. 9, a flow chart illustrating an exemplary procedure 901 for indicating a first router in a packet path will be discussed and described. The procedure can advantageously be implemented on, for example, a processor of a controller described in connection with FIG. 8 or other apparatus suitably arranged.

In overview, the illustrated procedure 901 for indicating the first router in a packet path includes associating 903 the router with the router location information. Thereafter, the procedure provides for determining 905 whether the router information is to be inserted, and if so, inserting 907 the router location information in the packet. The procedure then gets 909 the next packet to process, and repeats. Each of these is described in more detail below.

The illustrated procedure 901 provides for associating 903 the router with the router location information. For example, the router can be assigned a network routable address value in accordance with known techniques. The router can be assigned a physical address for example by interacting with a user or another device. In addition, the router location information can be assigned at initial configuration, or at a later point. Optional router location information can include conventionally stored information, for example line card numbers and/or port numbers. The router location information can be stored separately or collectively, and can be retrieved from the storage. Alternatively, the router location information can be collected and stored in local memory, and can be retrieved from the location memory. As in the illustrated process 901, the router location information can be associated with the router before commencing with the packet processing. Alternatively, the router location information can be associated with the router during the packet processing.

Thereafter, the illustrated procedure 901 provides for determining 905 whether the router information is to be inserted. For example, the router can automatically check whether a packet that is to be forwarded includes an indication that router location information is to be inserted. As discussed above in more detail, the indication can be the router location information field itself, or a separate indication (for example, a bit, flag or pointer). The separate indication can be useful for flagging packets which are desirably associated with a location, for example, packets associated with calls to 911, E911, roadside assistance, state police, or which are to be surveilled. The separate indication can alternatively be combined with the router location information for the checking. For example, router location information can be inserted if the indication is true and if the router location information field includes an empty value (for example, zero, negative, all bits on, or similar).

The procedure 901 also provides for inserting 907 the router location information in the packet, if the router information is to be inserted. The router location information can be retrieved from one or more locations in memory, and written into the appropriate location in the packet such as the router location information field. Further, if there is a separate indication in the packet, the separate indication can be set appropriately to indicate that router location information is not to be inserted.

Any other processing desired for the packet can also be performed. For example, the conventional processing of the packet can be performed.

It is anticipated that the procedure 901 can be realized in the processing for the appropriate layer. For example, if it is determined that the Layer 4 processing should include the router location information procedure, then the Layer 4 fields can be utilized for the procedure 901, and similarly for Layer 2, Layer 3, the application layer, and the like.

The procedure 901 then gets 909 the next packet to process, for example the next received packet, and repeats the processing. Thereby, each of the packets can be processed for router location information.

A computer-implemented method for indicating a first router in a packet path can be implemented, for example, on a router in a packet switching network. The method can include at the router, associating the router with router location information, wherein the router location information is at least one of a network routable address value unique to the router and a physical address corresponding to a geographic location of the router; at the router, automatically checking whether each packet of a plurality of packets that are received and are to be forwarded includes an indication that the router location information is to be inserted; at the router, if the packet includes the indication, automatically inserting the router location information into a router location information field in the packet; and at the router, if the packet does not include the indication, automatically not inserting router location information into the packet.

Optionally, the processing for router location information can be turned off at the router, for example when the processing is too time consuming or by a manual setting or by a command from the network.

Referring now to FIG. 10, a flow chart illustrating an exemplary procedure 1001 for providing an indication of an initial router in a path for a packet will be discussed and described. This procedure 1001 is an alternative to the embodiment illustrated in FIG. 9, and similarly can be implemented on, for example, a processor of a controller, described in connection with FIG. 8 or other apparatus appropriately arranged.

In overview, the illustrated procedure 1001 can include initially configuring 1003 to provide the specific router location information. Then, the procedure 1001 loops to continuously process packets as follows: receiving 1005 the next packet to be forwarded over the packet switching network; processing 1007 the packet in accordance with the associated layer; checking 1009 the packet to determine if there is any router location information in the packet; if 1011 the router location information is not in the packet, obtaining 1013 and inserting the specific router location information into the packet; and optionally performing any further processing 1015 of the packet for the associated layer. Each of these is discussed below.

One or more embodiments of the procedure 1001 provide for an initial configuration 1003 to assign the specific router location information, which is specific to the router location and can be inserted into the packets. The initial router configuration has been discussed above. The initial router configuration to assign specific router location information can be conveniently performed in connection with a conventional router configuration. Alternatively, the initial router configuration can be supplemented with specific router location information after the initial router configuration. Accordingly, the computer can be initially configured for executing the instructions to provide the specific router location information.

The procedure 1001 can include receiving 1005 the next packet to be forwarded over the packet switching network. This can be performed in accordance with conventional techniques.

When the packet has been received, the packet can be processed 1007 in accordance with the conventional techniques for the associated layer, if any. This can include, for example, error checking and other functions that will be understood by one of skill in the art. The processing 1007 according to the associated layer can be performed before and/or after handling the router location information.

The procedure 1001 also includes checking 1009 the packet to determine if there is any router location information in the packet. Details have already been provided on checking for router location information. If the router location information 1011 is not in the packet, then the procedure 1001 can obtain 1013 and insert the specific router location information into the packet. As previously described, the specific router location information can be retrieved from storage and inserted into the appropriate location in the packet, such as the router location information field. If there is a separate indication in the packet to indicate that router location information is to be inserted, the separate indication can be set appropriately to indicate that router location information is not to be inserted.

The procedure can performing any further processing 1015 of the packet, such as would be done for the associated layer.

Accordingly, a method may include receiving a packet that is to be forwarded over the packet switching network; responsive to receipt of the packet, processing the packet in accordance with an associated layer, including checking the packet to determine if any router location information is in the packet, and inserting specific router location information into the packet only if any router location information is not in the packet, wherein the specific router location information indicates the router that received the packet; and forwarding the packet after the processing. The checking can include checking whether the packet includes an indication that router location information is to be inserted into a router location information field in the packet. The inserting can include, only if the packet includes the indication, obtaining the specific router location information, and inserting the specific router location information into the packet.

Optionally, the router location information which is in the packet can be utilized in connection with other user-specified address information. For example NENA (National Emergency Number Association) calls for provision or registration of a physical address; the router location information in a packet can be double checked against the NENA address to provide improved physical address information.

It should be noted that the term router denotes a device or software that receives packets, determines a next network point to which packets should be forwarded toward their destinations, and then forwards the packets. A router sometimes can be located at or included as part of a gateway (where one network meets another), or a network switch, or a network bridge. Moreover, the router software can be included in other devices, for example, in some embodiments a CPE device can act as a router. In some embodiments, a router can act as a firewall. Examples of routers include devices and/or software which can be referred to as brouters, edge routers, or equivalents thereof.

Furthermore the communication networks of interest include those that transmit information in packets, for example, those known as packet switching networks that transmit data in the form of packets, where messages can be divided into packets before transmission, the packets are transmitted, and the packets are routed over routers to a destination where the packets are recompiled into the message. Such networks include, by way of example, the Internet, intranets, local area networks (LAN), wide area networks (WAN), and others. Protocols supporting communication networks that utilize packets include one or more of various networking protocols, such as TCP/IP (Transmission Control Protocol/Internet Protocol), Ethernet, X.25, Frame Relay, ATM (Asynchronous Transfer Mode), IEEE 802.11, UDP/UP (Universal Datagram Protocol/Universal Protocol), IPX/SPX (Inter-Packet Exchange/Sequential Packet Exchange), Net BIOS (Network Basic Input Output System), GPRS (general packet radio service), I-mode and other wireless application protocols, and/or other protocol structures, and variants and evolutions thereof. Such networks can provide wireless communications capability and/or utilize wireline connections such as cable and/or a connector, or similar.

This disclosure is intended to explain how to fashion and use various embodiments in accordance with the invention rather than to limit the true, intended, and fair scope and spirit thereof. The invention is defined solely by the appended claims, as they may be amended during the pendency of this application for patent, and all equivalents thereof. The foregoing description is not intended to be exhaustive or to limit the invention to the precise form disclosed. Modifications or variations are possible in light of the above teachings. The embodiment(s) was chosen and described to provide the best illustration of the principles of the invention and its practical application, and to enable one of ordinary skill in the art to utilize the invention in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally, and equitably entitled.

What is claimed is:

1. A router comprising:
a transceiver operable to transmit and receive packets when connected to a communication network; and
a processor cooperatively operable with the transceiver, the processor being associated with at least one of a unique network routable address value and a physical address, the processor being configured to facilitate receiving a packet in accordance with the transceiver; checking the packet for an indication to determine if the at least one of the unique network routable address value and the physical address are to be inserted in a router location information field in the packet; if the packet has the indication, inserting router location information indicative of the at least one of the unique network routable address value and the physical address in the packet; and transmitting the packet in accordance with the transceiver.

2. The router of claim 1, wherein the processor is further configured to facilitate obtaining the router location information from an initial router configuration.

3. The router of claim 1, wherein
a header in the packet incorporates the indication and the router location information field, and
the header is at least one of a layer 2 header, a layer 3 header, a layer 4 header, and an application layer header.

4. The router of claim 1, wherein
a header in the packet incorporates the indication, and the header indicates the router location information field is an extended field, and
the header is at least one of a layer 2 header, a layer 3 header, a layer 4 header, and an application layer header.

5. The router of claim 1, wherein
a header in the packet incorporates the indication, and the router location information field is incorporated in a payload of the packet, and
the header is at least one of a layer 2 header, a layer 3 header, a layer 4 header, and an application layer header.

6. The router of claim 1, wherein the router location information further comprises at least one of a line card number and a port number associated with the packet.

7. The router of claim 1, further comprising, before inserting the router location information, checking whether the router information location field has the router location information.

8. A computer-implemented method, implemented on a router in a packet switching network, for indicating a first router in a packet path, comprising:
at the router, associating the router with router location information, wherein the router location information is at least one of a network routable address value unique to the router and a physical address corresponding to a geographic location of the router;
at the router, automatically checking whether each packet of a plurality of packets that are received and are to be forwarded includes an indication that the router location information is to be inserted;
at the router, if the packet includes the indication, automatically inserting the router location information into a router location information field in the packet; and
at the router, if the packet does not include the indication, automatically not inserting router location information into the packet.

9. The method of claim 8, wherein the packet switching network is a voice over packet (VOP) network.

10. The method of claim 8, wherein the packet is received by the computer before the checking and inserting, further comprising transmitting the packet with the router location information to a next router in the packet path.

11. The method of claim 8, wherein a header in the packet includes the indication, and wherein the packet includes the router location information field as an extended field, wherein the header is at least one of a layer 2 header, a layer 3 header, a layer 4 header, and an application layer header.

12. The method of claim 8, wherein a header in the packet includes the indication, and wherein the router location information field is incorporated in a payload of the packet, wherein the header is at least one of a layer 2 header, a layer 3 header, a layer 4 header, and an application layer header.

13. The method of claim 8, wherein the indication is the router location information field in a header in the packet, wherein the header is at least one of a layer 2 header, a layer 3 header, a layer 4 header, and an application layer header.

14. A computer-readable medium comprising instructions for execution by a computer corresponding to a router, the instructions including a computer-implemented method for providing an indication of an initial router in a path for a packet on a packet switching network, the instructions for implementing:
(A) receiving a packet that is to be forwarded over the packet switching network;
(B) responsive to receipt of the packet, processing the packet in accordance with an associated layer, including checking the packet to determine if any router location information is in the packet, and inserting specific router location information into the packet only if any router location information is not in the packet, wherein the specific router location information indicates the router that received the packet; and
(C) forwarding the packet after the processing.

15. The computer-readable medium of claim 14, wherein
the checking includes checking whether the packet includes an indication that router location information is to be inserted into a router location information field in the packet; and
the inserting includes, only if the packet includes the indication, obtaining the specific router location information, and inserting the specific router location information into the packet.

16. The computer-readable medium of claim 15, wherein a header in the packet incorporates the router location information field, wherein the header is at least one of a layer 2 header, a layer 3 header, a layer 4 header, and an application layer header.

17. The computer-readable medium of claim 15, wherein a header in the packet indicates the router location information field as an extended field, wherein the header is at least one of a layer 2 header, a layer 3 header, a layer 4 header, and an application layer header.

18. The computer-readable medium of claim 15, wherein the router location information field is incorporated in a payload of the packet.

19. The computer-readable medium of claim 14, wherein the router location information is at least one of a unique network routable address value associated with the router corresponding to the computer that is executing the instructions, and a physical address corresponding to a geographic location of the router, further comprising instructions for obtaining the router location information to be inserted.

20. The computer-readable medium of claim 14, further comprising instructions for initially configuring the computer executing the instructions to provide the specific router location information.
